(19) United States
(12) Patent Application Publication
(10) Pub. No.: US 2024/0358045 A1
(43) Pub. Date: Oct. 31, 2024

(54) METHOD OF DETERMINING FEED FOR ALGAE-EATING FISH AND SHELLFISH, METHOD OF FEEDING ALGAE-EATING FISH AND SHELLFISH, AND METHOD OF PRODUCING FEED

(71) Applicant: NIPPON TELEGRAPH AND TELEPHONE CORPORATION, Tokyo (JP)

(72) Inventors: Sosuke IMAMURA, Musashino-shi, Tokyo (JP); Kazuhiro TAKAYA, Musashino-shi, Tokyo (JP)

(73) Assignee: NIPPON TELEGRAPH AND TELEPHONE CORPORATION, Tokyo (JP)

(21) Appl. No.: 18/291,921

(22) PCT Filed: Jul. 29, 2021
(86) PCT No.: PCT/JP2021/028116

§ 371 Date: Jan. 25, 2024

(51) Int. Cl. A23K 50/80; A01K 61/50

(52) U.S. Cl. CPC A23K 50/80; A01K 61/50

(57) ABSTRACT

A technology for enhancing ingestion efficiency of algae-eating fish and shellfish is provided. A method of determining feed for algae-eating fish and shellfish includes: feeding algae-eating fish or shellfish with a plurality of samples, the samples each containing algal cells and being different from each other in a stage of growth or division of the algal cells; and selecting, as a feed for giving to the algae-eating fish or shellfish, the algal cells whose stage of growth or division is the same as that of the algal cells contained in the sample most preferably eaten by the algae-eating fish or shellfish.

### TECHNICAL FIELD

The present invention relates to a method of determining feed for algae-eating fish and shellfish, a method of feeding algae-eating fish and shellfish, and a method of producing the feed.

### BACKGROUND ART

Studies on feeding of algae-eating fish and shellfish such as Japanese pearl oyster, Pinctada fucata martensii, have been conducted. For example, Non Patent Literature 1 is a literature relating to feeding of Japanese pearl oyster juveniles, and reports the ingestion rate, the digestion rate, and the phyto-pigment content in the digestive diverticula of Japanese pearl oyster juveniles, with respect to six kinds of microalgae. Non Patent Literature 2 is a literature relating to feeding of Japanese pearl oyster after nucleus implantation, and, more particularly, reports the weight gain rate, the protein content, and the content of highly unsaturated fatty acid Of Japanese pearl oyster after nucleus implantation, with respect to two kinds of microalgae.

### CITATION LIST

### Non Patent Literature

Non Patent Literature 1: “Comparison of the ingestion rate, digestion rate and phyto-pigment content in the digestive diverticula of Japanese pearl oyster, Pinctada fucata martensii, juveniles grazing six different micro-algae”, Nippon Suisan Gakkaishi, 68 (4), 534-537 (2002) Non Patent Literature 2: “Dietary value of marine microalgae for the growth of Japanese pearl oyster Pinctada fucata martensii after nucleus implantation”, The bulletin of the Graduate School of Bioresources, Mie University, 44, 1-5 (2018)

### SUMMARY OF INVENTION

### Technical Problem

The present invention aims to provide a technology for enhancing ingestion efficiency of algae-eating fish and shellfish.

### Solution to Problem

According to a first aspect of the present invention, a method of determining feed for algae-eating fish and shellfish is provided,
the method including:
feeding algae-eating fish or shellfish with a plurality of samples, the samples each containing algal cells and being different from each other in a stage of growth or division of the algal cells; and
selecting, as a feed for giving to the algae-eating fish or shellfish, the algal cells whose stage of growth pr division is the same as that of the algal cells contained in the sample most preferably eaten by the algae-eating fish or shellfish.

According to a second aspect of the present invention, a method of determining feed for algae-eating fish and shellfish is provided,
the method including:
feeding algae-eating fish or shellfish with one or more samples, each of the one or more samples containing algal cells differing from each other in a stage of growth or division; and
selecting, as a feed for giving to the algae-eating fish or shellfish, the algal cells whose stage of growth or division is the same as that of the algal cells most preferably eaten by the algae-eating fish or shellfish.

According to a third aspect of the present invention, a method of feeding algae-eating fish and shellfish is provided, the method including feeding the algae-eating fish or shellfish with the feed determined by the method according to the first aspect or the second aspect.

According to a fourth aspect of the present invention, a method of producing the feed determined by the method according to the first aspect or the second aspect is provided,
the method including:
culturing the algal cells; and
obtaining, from the cultured algal cells, the algal cells which are in the same stage of growth or division as the algal cells most preferably eaten by the algae-eating fish or shellfish, as the feed.

### Advantageous Effects of Invention

The present invention is to provide a technology for enhancing ingestion efficiency of algae-eating fish and shellfish.

### BRIEF DESCRIPTION OF DRAWINGS

FIG. 1 is a schematic diagram illustrating how a eukaryotic algal cell grows and divides.

FIG. 2 is a schematic diagram illustrating an example method of determining feed according to a first embodiment.

FIG. 3 is a schematic diagram illustrating another example method of determining feed according to the first embodiment.

FIG. 4 is a schematic diagram illustrating an example method of determining feed according to a second embodiment.

### DESCRIPTION OF EMBODIMENTS

The following is a description of embodiments of the present invention. In the embodiments described below, one of the above aspects is further embodied. The matters described below can be incorporated into each of the above aspects independently of each other or in combination.

### 1. Method of Determining Feed for Algae-Eating Fish and Shellfish

### 1-1. First Embodiment

A “method of determining feed for algae-eating fish and shellfish” according to a first embodiment of the present invention includes:
feeding algae-eating fish or shellfish with a plurality of samples, the samples each containing algal cells and being different from each other in a stage of growth or division of the algal cells; and
selecting, as a feed for giving to the algae-eating fish or shellfish, the algal cells whose stage of growth or division is the same as that of the algal cells contained in the sample most preferably eaten by the algae-eating fish or shellfish.

### Explanation of Terms

The term “algae-eating fish and/or shellfish” is a general term for algae-eating aquatic animals such as algae-eating fish and algae-eating shellfish, and refers to aquatic animals such as fish and shellfish that graze on algae. The algae-eating fish is juvenile fish, for example, and the algae-eating shellfish is Japanese pearl oyster, Pinctada fucata martensii, for example.

The term “algae” refers to microalgae. Microalgae are photosynthetic eukaryotes, for example, and are unicellular organisms or colonies thereof. Examples of the microalgae include unicellular green algae such as Chlamydomonas reinhardtti and Botryococcus, unicellular red algae such as Cyanidioschyzon merolae, diatom such as Phaeodactylum, or colonies thereof. The microalgae may not be eukaryotes, but may be prokaryotes that perform photosynthesis, for example, bacteria such as cyanobacteria.

### Sample Preparation Step

In the method according to the first embodiment, the “plurality of samples, the samples each containing algal cells and being different from each other in a stage of growth or division of the algal cells” is first prepared. In this method, the algal cells contained in one sample are in one particular stage of growth or division. In this method, which sample of the plurality of samples is most preferably eaten by algae-eating fish or shellfish is determined through comparison. Therefore, all the samples in the plurality of samples are identical, except that the stages of growth or division of algal cells are different. That is, the plurality of samples includes algal cells of the same strain, and differ only in the stage of growth or division of the algal cells. The plurality of samples is two or more kinds of samples, and the upper limit is not limited to any particular number. The plurality of samples can be two to eight kinds of samples, for example.

Algae proliferate by repeating growth and division. A process in which a cell immediately after division grows and divides into two is called a cell cycle. Cell cycles are classified into eight phases: the G1 phase (DNA synthesis preparation phase), the S phase (DNA synthesis phase), the G2 phase (division preparation phase), the early M phase (division phase), the middle M phase, the late M phase, the terminal M phase, and the G0 phase (stationary phase), for example.

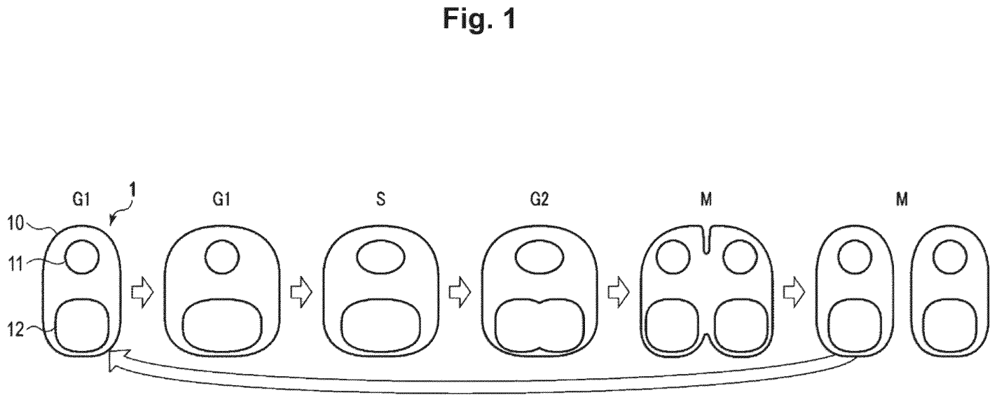

FIG. 1 schematically illustrates how a eukaryotic algal cell grows and divides. In FIG. 1, an algal cell 1 includes a cell wall 10 and cytoplasm surrounded by this cell wall. The cytoplasm contains a nucleus 11 and a chloroplast 12. As illustrated in FIG. 1, in the G1 phase, DNA synthesis is prepared, and the cell grows. Subsequently, chromosomal DNA is replicated in the S phase. After the chromosomal DNA replication is completed, the algal cell enters the G2 phase, and prepares for division. After that, in the early M phase, chromosome condensation occurs. In the middle M phase, the nuclear membrane disappears, and the chromosomes are aligned in the equatorial plane. In the late M phase, the chromatids are pulled by the spindle and are separated. In the terminal M phase, the chromatids are decondensed, the nuclear membrane is reformed, and the cytoplasm divides. The phase during which neither cell growth nor cell division occurs is called the G0 phase.

Accordingly, as the “plurality of samples, the samples each containing algal cells and being different from each other in a stage of growth or division of the algal cells”, “a plurality of samples, the samples each containing algal cells and being different from each other in a cell cycle of the algal cells” can be prepared, for example. Specifically, the following eight kinds of samples can be prepared.
Sample A1: algal cells in the G1 phase
Sample A2: algal cells in the S phase
Sample A3: algal cells in the G2 phase
Sample A4: algal cells in the early M phase
Sample A5: algal cells in the middle M phase
Sample A6: algal cells in the late M phase
Sample A7: algal cells in the terminal M phase
Sample A8: algal cells in the G0 phase

These samples can be prepared by culturing algal cells with their cell cycles synchronized during culture. A technique for culturing algal cells with their cell cycles synchronized during culture is known as a synchronous culture method. For example, when algal cells are cultured while the culture environment is alternately switched between a light environment and a dark environment, the cell cycles of the algal cells can be synchronized. Algal cells perform photosynthesis in a light environment. When the light environment is switched to a dark environment, the photosynthesis activity decreases, and the cells shift from the G1 phase to the S phase to advance the cell cycles. Thus, the cell cycles can be synchronized. Alternatively, the algal cells can be cultured in a culture solution containing a cell division inhibitor or a cell growth inhibitor, to stop the cell cycles at a specific stage. The algal cells are then cultured in the absence of the inhibitor, so that the cell cycles can be synchronized. Such an inhibitor can be a DNA replication inhibitor, a microtubule formation inhibitor, or the like.

### Sample Supply Step

In the method according to the first embodiment, the respective prepared samples (i.e., a plurality of samples, the samples each containing algal cells and being different from each other in a stage of growth or division of the algal cells) are fed to the algae-eating fish or shellfish. The samples can be fed to the algae-eating fish or shellfish so that 1×10⁴ to 1×10⁶ algal cells are supplied per 1 mL of breeding water in which the fish or shellfish is bred, for example. The samples may be supplied once or a plurality of times. In a case where the samples are supplied a plurality of times, the samples can be supplied every two to twelve hours. In the case where the samples are supplied a plurality of times, the number of times the supply is performed is 2 to 28, for example.

In this method, which sample of the plurality of samples is most preferably eaten by algae-eating fish or shellfish is determined through comparison. Therefore, the test conditions such as supply conditions are preferably the same for all the samples. The test conditions include the concentration of the samples to be supplied (i.e., the number of algal cells), and the breeding environment of the algae-eating fish or shellfish before and during the supply (e.g., the feeding status prior to the supply). For example, for all the samples, it is preferable to keep the algae-eating fish or shellfish in a fasted state before giving the samples to the algae-eating fish or shellfish. Alternatively, for all the samples, it is preferable to keep the algae-eating fish or shellfish in a full state before giving the samples to the algae-eating fish or shellfish.

### Feed Selection Step

After the samples are supplied to the algae-eating fish or shellfish, algal cells which are in the same stage of growth or division as the algal cells most preferably eaten by the algae-eating fish or shellfish are selected as the feed for giving to the algae-eating fish or shellfish. Here, the algal cells are selected as at least part of the feed for ginving to the algae-eating fish or shellfish. In other words, the algal cells selected herein may be used as part of the feed for giving to the algae-eating fish or shellfish, or may be used as all of the feed for giving to the algae-eating fish or shellfish.

The selection of the feed can be performed through a check as to which samples of the plurality of samples were most preferably eaten by the algae-eating fish or shellfish.

Preferably, the selection of the feed can be performed by measuring the number of algal cells eaten by the algae-eating fish or shellfish for each of the algae-eating fish or shellfish to which the samples were supplied, and determining which stage of growth or division of the algal cells was most preferably eaten by the algae-eating fish or shellfish, on the basis of the result of the measurement. The number of algal cells eaten by the algae-eating fish or shellfish may be measured by taking out the eaten algal cells from the algae-eating fish or shellfish and directly measuring the number of algal cells, or may be indirectly measured by measuring the number of algal cells remaining in the breeding water without having been eaten. The number of algal cells can be measured with a hemocytometer or by flow cytometry, for example.

Alternatively, the selection of the feed can be performed by measuring the intake amount of algae-derived bioconstituents eaten by the algae-eating fish or shellfish (e.g., DHA and EPA) for each of the algae-eating fish or shellfish to which the samples were supplied, and determining which stage of growth or division of the algal cells was most preferably eaten by the algae-eating fish or shellfish, on the basis of the result of the measurement. In this method, the intake amount of the algae-derived bioconstituents eaten by the algae-eating fish or shellfish is first measured by analyzing lipids contained in the algae-eating fish or shellfish by gas chromatography tandem mass spectrometry (GC-MS/MS), for example. Next, the measured intake amount is divided by the amount of the bioconstituents contained in one cell of the algal cells fed to the algae-eating fish or shellfish, to calculate the number of algal cells eaten by the algae-eating fish or shellfish. This makes it possible to determine which stage of growth or division of the algal cells was most preferably eaten by the algae-eating fish or shellfish.

The selection of the feed can be performed one to five hours after the supply of the samples, for example. There is a possibility that the algal cells supplied as samples may progress through the stage of growth or division between the supply of the samples and the selection of the feed. Therefore, regarding the sample most preferably eaten by the algae-eating fish or shellfish, it is preferable to check whether or not the stage of growth or division of the sample (i.e., algal cells) remaining in the breeding water has progressed at the time of selecting the feed. In this checking process, in a case where the stage of growth or division of the sample has not progressed, it is possible to select, as the feed, the algal cells which are in the same stage of growth or division as the sample most preferably eaten by the algae-eating fish or shellfish. Alternatively, in a case where the stage of growth or division has progressed in the checking process, the algal cells having a period of time from the stage of growth or division of the sample at the time of supply to an advanced stage can be selected as the feed. In the latter case, if the period from the supply of the sample to the selection of the feed is made shorter so that the stage of growth or division will not progress between the supply of the sample and the selection of the feed, it is possible to determine which stage of growth or division the sample most preferably eaten by the algae-eating fish or shellfish is in.

### Specific Example 1

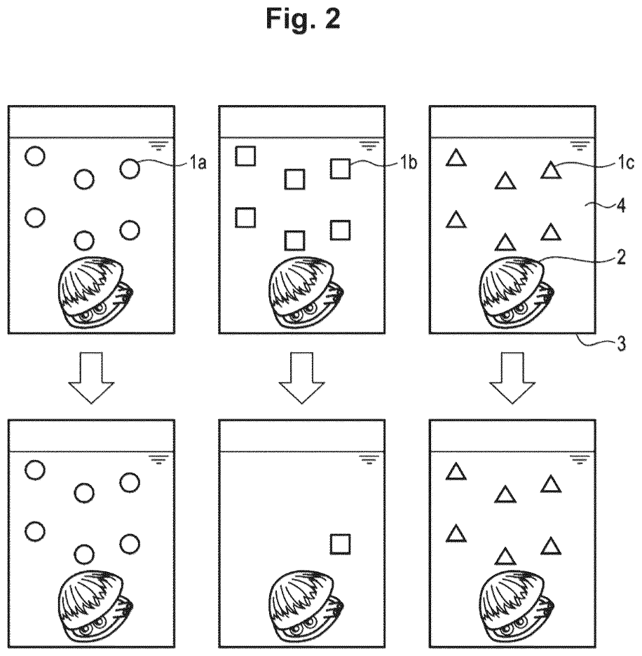

FIG. 2 schematically illustrates an example method of determining feed according to the first embodiment. In FIG. 2, algae-eating shellfish 2 is being bred in breeding water 4 contained in a culture vessel 3. Although the above-mentioned eight kinds of samples (samples A1 to A8) were supplied to the algae-eating shellfish 2 in this example, FIG. 2 illustrates a representative case where Samples A1 to A3 (i.e., algal cells 1a in the G1 phase, algal cells 1b in the S phase, and algal cells 1c in the G2 phase) were supplied.

In FIG. 2, a test in which the algal cells 1a in the G1 phase were supplied as a sample is shown in the left column, a test in which the algal cells 1b in the S phase were supplied as a sample is shown in the middle column, and a test in which the algal cells 1c in the G2 phase were supplied as a sample is shown in the right column. Also, in FIG. 2, the drawings in the upper row show the states immediately after the samples were supplied to the algae-eating shellfish 2, and the drawings in the lower row show the states after a predetermined time elapsed since the samples were supplied to the algae-eating shellfish 2.

In this example, after feeding of five algae-eating shellfish 2 is stopped, and the five algae-eating shellfish 2 are left in a fasted state for three days, for example, the samples are supplied every twelve hours a total of 28 times, and the number of algal cells eaten by the algae-eating shellfish 2 is measured after three hours have elapsed since each supply of the samples. Here, each supply of the samples is performed so that 1×10⁴ to 1×10⁶ algal cells are supplied per 1 mL of shellfish breeding water, for example. After the algae-eating shellfish is put into a fasted state, it is preferable to supply the samples a plurality of times. When the samples are supplied a plurality of times, the preferences of the algae-eating shellfish can be more accurately examined. In FIG. 2, the algae-eating shellfish 2 most preferably ate the algal cells 1b in the S phase. Accordingly, the algal cells 1b in the S phase can be selected as the feed for giving to algae-eating shellfish.

### Specific Example 2

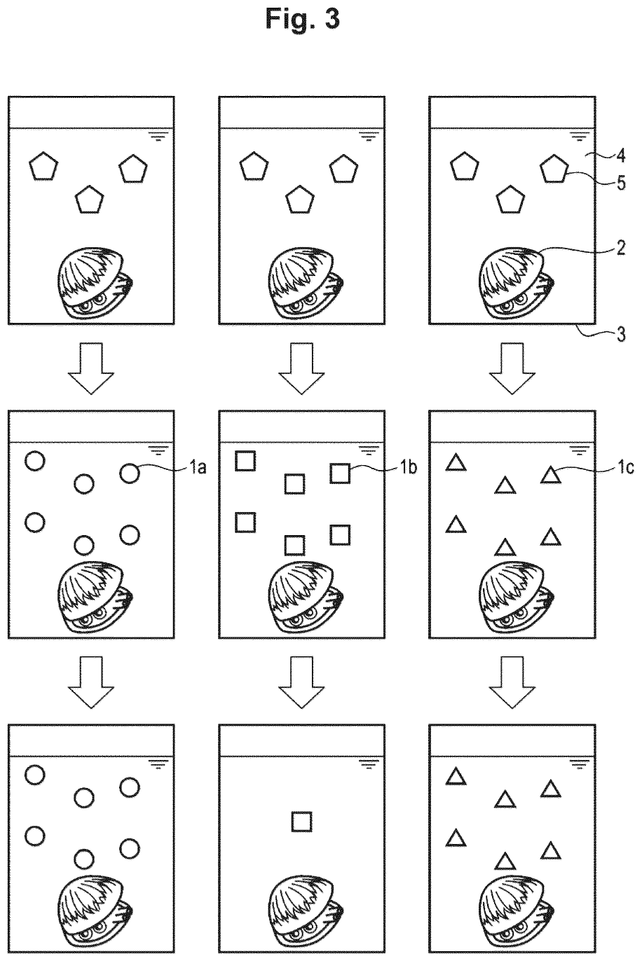

FIG. 3 schematically illustrates another example method of determining feed according to the first embodiment. In FIG. 3, algae-eating shellfish 2 is being bred in breeding water 4 contained in a culture vessel 3. Although the above-mentioned eight kinds of samples (samples A1 to A8) were supplied to the algae-eating shellfish 2 in this example, FIG. 3 illustrates a representative case where samples A1 to A3 (i.e., algal cells 1a in the G1 phase, algal cells 1b in the S phase, and algal cells 1c in the G2 phase) were supplied.

In FIG. 3, a test in which the algal cells 1a in the G1 phase were supplied as a sample is shown in the left column, a test in which the algal cells 1b in the S phase were supplied as a sample is shown in the middle column, and a test in which the algal cells 1c in the G2 phase were supplied as a sample is shown in the right column. Also, in FIG. 3, the drawings in the upper row show the states after artificial feed 5 was supplied to put the algae-eating shellfish 2 into a full state before the samples were supplied to the algae-eating shellfish 2, the drawings in the middle row show the states immediately after the samples were supplied to the algae-eating shellfish 2, and the drawings in the lower row show the states after a predetermined time elapsed since the samples were supplied to the algae-eating shellfish 2.

In this example, after five algae-eating shellfish 2 are given the artificial feed 5 to put the algae-eating shellfish 2 into a full state, for example, the samples are supplied once, and the number of algal cells eaten by the algae-eating shellfish 2 is measured after three hours have elapsed since the supply of the samples. A full state can be achieved by giving the artificial feed 5 in such an amount that the artificial feed 5 remains in the breeding water for a certain period of time after the feeding. In place of the artificial feed 5, a mixture of algal cells in various stages of growth or division may be supplied to achieve a full state. Further, the supply of the samples is performed so that 1×10⁴ to 1×10⁶ algal cells are supplied per 1 mL of shellfish breeding water, for example. In FIG. 3, the algae-eating shellfish 2 most preferably ate the algal cells 1b in the S phase. Accordingly, the algal cells 1b in the S phase can be selected as the feed for giving to algae-eating shellfish.

### 1-2. Second Embodiment

A “method of determining feed for algae-eating fish and shellfish” according to a second embodiment of the present invention includes:
feeding algae-eating fish or shellfish with one or more samples, each of the one or more samples containing algal cells differing from each other in a stage of growth or division; and
selecting, as a feed for giving to the algae-eating fish or shellfish, the algal cells whose stage of growth or division is the same as that of the algal cells most preferably eaten by the algae-eating fish or shellfish.

The method according to the second embodiment is described below in detail. However, the following description does not include the explanation of contents overlapping with the method according to the first embodiment, but includes the explanation of contents differing from the method according to the first embodiment.

### Sample Preparation Step

In the method according to the first embodiment, “a plurality of samples, the samples each containing algal cells and being different from each other in a stage of growth or division of the algal cells” is prepared as the samples to be supplied to algae-eating fish or shellfish. In the method according to the second embodiment, “one or more samples, each of the one or more samples containing algal cells differing from each other in a stage of growth or division” are prepared as the samples to be supplied to the algae-eating fish or shellfish. That is, in the method according to the first embodiment, the algal cells contained in one sample are in one specific stage of growth or division. In the method according to the second embodiment, on the other hand, a combination of algal cells in different stages of growth or division are contained in one sample. In the method according to the second embodiment, samples may be prepared so that algal cells in different stages of growth or division are contained in the same number in one sample, or samples may be prepared so that algal cells in different stages of growth or division are contained in different numbers in one sample. In either case, it is possible to determine which stage of the algal cells was most preferably eaten by algae-eating fish or shellfish, among algal cells in different stages of growth or division.

Preferably, in the method according to the second embodiment, “a plurality of samples, each containing algal cells differing from each other in a stage of growth or division” is prepared as the samples to be supplied to algae-eating fish or shellfish. The plurality of samples is identical, except that the stages of growth or division of algal cells are different. That is, the plurality of samples includes algal cells of the same strain, and differ only in the stage of growth or division of the algal cells. The expression “different” herein means that the stages of growth or division are at least partially different. The plurality of samples is two or more kinds of samples, and the upper limit is not limited to any particular number. The plurality of samples can be two to eight kinds of samples, for example.

As the “plurality of samples, each containing algal cells differing from each other in a stage of growth or division”, samples each obtained by combining algal cells in two of the eight cell cycle phases can be used, for example. The samples in this case are specifically as follows.
Sample B1: a mixture of algal cells in the G1 phase and algal cells in the S phase
Sample B2: a mixture of algal cells in the G1 phase and algal cells in the G2 phase
Sample B3: a mixture of algal cells in the G1 phase and algal cells in the early M phase
Sample B4: a mixture of algal cells in the G1 phase and algal cells in the middle M phase
Sample B5: a mixture of algal cells in the G1 phase and algal cells in the late M phase
Sample B6: a mixture of algal cells in the G1 phase and algal cells in the terminal M phase
Sample B7: a mixture of algal cells in the G1 phase and algal cells in the G0 phase
Sample B8: a mixture of algal cells in the S phase and algal cells in the G2 phase
Sample B9: a mixture of algal cells in the S phase and algal cells in the early M phase
Sample B10: a mixture of algal cells in the S phase and algal cells in the middle M phase
Sample B11: a mixture of algal cells in the S phase and algal cells in the late M phase
Sample B12: a mixture of algal cells in the S phase and algal cells in the terminal M phase
Sample B13: a mixture of algal cells in the S phase and algal cells in the G0 phase
Sample B14: a mixture of algal cells in the G2 phase and algal cells in the early M phase
Sample B15: a mixture of algal cells in the G2 phase and algal cells in the middle M phase
Sample B16: a mixture of algal cells in the G2 phase and algal cells in the late M phase
Sample B17: a mixture of algal cells in the G2 phase and algal cells in the terminal M phase
Sample B18: a mixture of algal cells in the G2 phase and algal cells in the G0 phase
Sample B19: a mixture of algal cells in the early M phase and algal cells in the middle M phase
Sample B20: a mixture of algal cells in the early M phase and algal cells in the late M phase
Sample B21: a mixture of algal cells in the early M phase and algal cells in the terminal M phase
Sample B22: a mixture of algal cells in the early M phase and algal cells in the G0 phase
Sample B23: a mixture of algal cells in the middle M phase and algal cells in the late M phase
Sample B24: a mixture of algal cells in the middle M phase and algal cells in the terminal M phase
Sample B25: a mixture of algal cells in the middle M phase and algal cells in the G0 phase
Sample B26: a mixture of algal cells in the late M phase and algal cells in the terminal M phase
Sample B27: a mixture of algal cells in the late M phase and algal cells in the G0 phase
Sample B28: a mixture of algal cells in the terminal M phase and algal cells in the G0 phase

As the “plurality of samples, each containing algal cells differing from each other in a stage of growth or division”, all of samples B1 to B28 may be used, or some of samples B1 to B28 may be used. For example, the seven kinds of samples B1 to B7 may be used as the “plurality of samples, each containing algal cells differing from each other in a stage of growth or division”.

Alternatively, as each sample of the “plurality of samples, each containing algal cells differing from each other in a stage of growth or division”,
a sample combining algal cells in three of the eight cell cycle phases may be used,
a sample combining algal cells in four of the eight cell cycle phases may be used,
a sample combining algal cells in five of the eight cell cycle phases may be used,
a sample combining algal cells in six of the eight cell cycle phases may be used, or
a sample combining algal cells in seven of the eight cell cycle phases may be used.

### Sample Supply Step

The supply of the samples to the algae-eating fish or shellfish can be performed by the same procedures as the method according to the first embodiment.

Also in the method according to the second embodiment, which stage of growth or division of the algal cells is most preferably eaten by algae-eating fish or shellfish are determined through comparison among algal cells in different stages of growth or division. Therefore, the test conditions such as supply conditions are preferably the same for all the samples. For example, for all the samples, it is preferable to keep the algae-eating fish or shellfish in a fasted state before giving the samples to the algae-eating fish or shellfish. Alternatively, for all the samples, it is preferable to keep the algae-eating fish or shellfish in a full state before giving the samples to the algae-eating fish or shellfish.

### Feed Selection Step

As described above, in the second embodiment, algal cells differing from each other in a stage of growth or division are contained in one sample. Accordingly, the selection of the feed can be performed by taking out the algal cells eaten by the algae-eating fish or shellfish from the algae-eating fish or shellfish to determine the stages of growth or division of the algal cells for each of the algae-eating fish or shellfish to which the samples were supplied, measuring the number of algal cells eaten by the algae-eating fish or shellfish for each of the stages of growth or division of algal cells, and determining which stage of growth or division of the algal cells was most preferably eaten by the algae-eating fish or shellfish, on the basis of the result of the measurement. The stages of growth or division of the algal cells can be determined by observation with a microscope.

### Specific Example 3

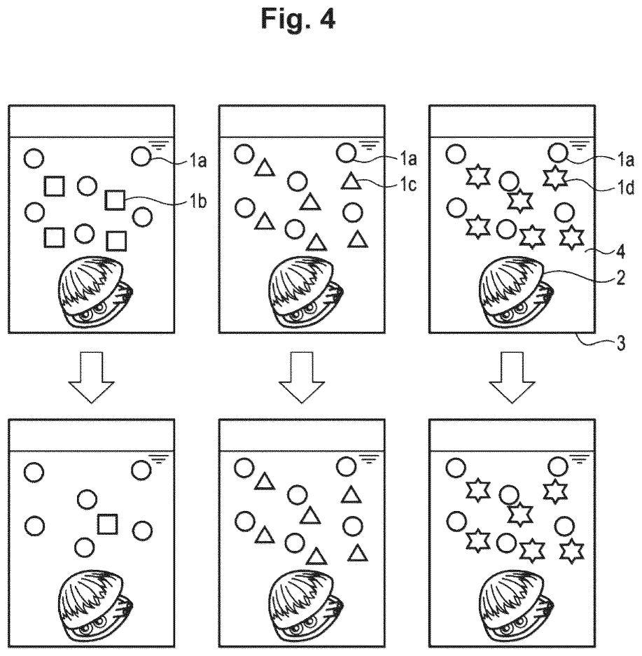

FIG. 4 schematically illustrates an example method of determining feed according to the second embodiment. In

FIG. 4, algae-eating shellfish 2 is being bred in breeding water 4 contained in a culture vessel 3. Although the above-mentioned 28 kinds of samples (samples B1 to B28) were supplied to the algae-eating shellfish 2 in this example, FIG. 4 illustrates a representative case where samples B1 to B3 (i.e., the mixture of the algal cells 1a in the G1 phase and the algal cells 1b in the S phase, the mixture of the algal cells 1a in the G1 phase and the algal cells 1c in the G2 phase, and the mixture of the algal cells 1a in the G1 phase and the algal cells 1d in the early M phase) were supplied.

In FIG. 4, a test in which the mixture of the algal cells 1a in the G1 phase and the algal cells 1b in the S phase was supplied as a sample is shown in the left column, a test in which the mixture of the algal cells 1a in the G1 phase and the algal cells 1c in the G2 phase was supplied as a sample is shown in the middle column, and a test in which the mixture of the algal cells 1a in the G1 phase and the algal cells 1d in the early M phase was supplied as a sample is shown in the right column. Also, in FIG. 4, the drawings in the upper row show the states immediately after the samples were supplied to the algae-eating shellfish 2, and the drawings in the lower row show the states after a predetermined time elapsed since the samples were supplied to the algae-eating shellfish 2.

In this example, after feeding of five algae-eating shellfish 2 is stopped, and the five algae-eating shellfish 2 are left in a fasted state for three days, for example, the samples are supplied every twelve hours a total of 28 times, the cell cycle phases of the algal cells eaten by the algae-eating shellfish 2 are determined after three hours have elapsed since each supply of the samples, and the number of algal cells eaten by the algae-eating fish or shellfish is measured for each stage of growth or division of the algal cells. Here, each supply of the samples is performed so that 1×10⁴ to 1×10⁶ algal cells are supplied per 1 mL of shellfish breeding water, for example. In FIG. 4, the algae-eating shellfish 2 most preferably ate the algal cells 1b in the S phase. Accordingly, the algal cells 1b in the S phase can be selected as the feed for giving to algae-eating shellfish.

### 1-3. Effects

When which stage of growth or division the algal cells is preferably eaten by algae-eating fish or shellfish is determined by the “method of determining feed for algae-eating fish or shellfish” described above, algal cells in the determined stage are selectively given to algae-eating fish or shellfish, so that ingestion efficiency and nutrient intake efficiency of algae-eating fish or shellfish can be enhanced. Thus, growth of algae-eating fish or shellfish can be facilitated, and, as a result, productivity of algae-eating fish or shellfish can be increased.

When algal cells in different stages of growth or division are supplied in combination by the method according to the second embodiment, it is possible to capture algal cells eaten specifically from among mixtures of algal cells in different stages of growth or division. Thus, it is possible to more accurately determine which stage of the algal cells is preferably eaten by algae-eating fish or shellfish.

Conventionally, in breeding or cultivation of algae-eating fish or shellfish, algae are supplied, regardless of stages of growth or division of algal cells, and the algae to be supplied are a mixture of algal cells in various stages of growth or division. When the present inventors supplied algal cells in different stages of growth or division in combination, only some of the supplied algae were preferably eaten by algae-eating fish or shellfish. Therefore, in conventional breeding and cultivation, supplied algae only partially function as the feed, and it is considered that ingestion efficiency and nutrient intake efficiency of algae-eating fish or shellfish are low.

### 2. Method of Feeding Algae-Eating Fish and Shellfish

A “method of feeding algae-eating fish and shellfish” according to an embodiment of the present invention includes feeding the algae-eating fish or shellfish with the feed determined by the above “method of determining feed for algae-eating fish and shellfish”.

A “method of feeding algae-eating fish and shellfish” according to a preferred embodiment includes:
feeding the algae-eating fish or shellfish with feed determined by the above “method of determining feed for algae-eating fish and shellfish”;
culturing the algal cells; and
obtaining, from the cultured algal cells, algal cells which are in the same stage of growth or division as the algal cells most preferably eaten by the algae-eating fish or shellfish, as the feed.

The “method of feeding algae-eating fish and shellfish” can also be expressed as a “method of breeding algae-eating fish and shellfish” or a “method of producing algae-eating fish and shellfish”.

### Feed Supply Step

Feed can be given to algae-eating fish or shellfish so that 1×10⁴ to 1×10⁶ algal cells are supplied per 1 mL of breeding water, for example. The feed can be supplied at intervals of two to twelve hours, for example.

### Algal Cell Culturing Step

Algal cells can be cultured by suspension culture in a liquid medium containing a sufficiently high concentration of nutrients necessary for the algal cells to perform photosynthesis, growth, division, and the like. The culture of algal cells may be conducted in an open culture tank called an open pond, or may be conducted in a closed system called a closed photobioreactor, for example.

### Feed Acquisition Step

From the cultured algal cells, those in the same stage of growth or division as those most preferably eaten by the algae-eating fish or shellfish are obtained as the feed, and the obtained feed is given to algae-eating fish or shellfish.

The feed can be obtained by the procedures described in the chapter “Sample Preparation Step” of the method according to the first embodiment described above. That is, it is possible to obtain the feed by culturing algal cells with their cell cycles synchronized during culture. For example, when algal cells are cultured while the culture environment is alternately switched between a light environment and a dark environment, the cell cycles of the algal cells can be synchronized. Algal cells perform photosynthesis in a light environment. When the light environment is switched to a dark environment, the photosynthesis activity decreases, and the cells shift from the G1 phase to the S phase to advance the cell cycles. Thus, the cell cycles can be synchronized. Alternatively, the algal cells can be cultured in a culture solution containing a cell division inhibitor or a cell growth inhibitor, to stop the cell cycles at a specific stage. The algal cells are then cultured in the absence of the inhibitor, so that the cell cycles can be synchronized. Such an inhibitor can be a DNA replication inhibitor, a microtubule formation inhibitor, or the like.

For example, “algal cells having its cell cycle in the S phase” can be obtained by culturing a mixture of algal cells in various stages of growth or division (hereinafter also referred to as raw material cells) while alternately switching the culture environment between a light environment and a dark environment, and collecting the cells after switching the culture environment from the light environment to the dark environment. Alternatively, “algal cells having its cell cycle in the S phase” can be obtained by culturing raw material cells in a culture solution containing a DNA replication inhibitor, then culturing the cells in the absence of the DNA replication inhibitor, and collecting the cells.

### Effects

In this method, the feed determined by the above “method of determining feed for algae-eating fish and shellfish” is selectively supplied to algae-eating fish or shellfish. Accordingly, it is possible to enhance ingestion efficiency and nutrient intake efficiency of algae-eating fish or shellfish. Thus, growth of algae-eating fish or shellfish can be facilitated, and, as a result, productivity of algae-eating fish or shellfish can be increased.

### 3. Method of Producing Feed

A “method of producing feed” according to an embodiment of the present invention is a method of producing the feed determined by the above “method of determining feed for algae-eating fish and shellfish”,
the method including:
culturing the algal cells; and
obtaining, from the cultured algal cells, algal cells which are in the same stage of growth or division as the algal cells most preferably eaten by the algae-eating fish or shellfish, as the feed.

This method can be implemented by the same procedures as those described in “2. Method of Feeding Algae-Eating Fish and Shellfish”. In this method, it is possible to produce feed for algae-eating fish or shellfish with excellent ingestion efficiency and nutrient intake efficiency.

### REFERENCE SIGNS LIST

1 algal cell
1a algal cells in the G1 phase
1b algal cells in the S phase
1c algal cells in the G2 phase
1d algal cells in the early M phase
2 algae-eating shellfish
3 culture vessel
4 breeding water
5 artificial feed
10 cell wall
11 nucleus
12 chloroplast

1. A method of determining feed for algae-eating fish and shellfish,
the method comprising:
feeding algae-eating fish or shellfish with a plurality of samples, the samples each containing algal cells and being different from each other in a stage of growth or division of the algal cells; and
selecting, as a feed for giving to the algae-eating fish or shellfish, the algal cells whose stage of growth or division is the same as that of the algal cells contained in the sample most preferably eaten by the algae-eating fish or shellfish.

2. The method according to claim 1, further comprising putting the algae-eating fish or shellfish into a fasted state, prior to the feeding the algae-eating fish or shellfish with the plurality of samples.

3. The method according to claim 1, further comprising putting the algae-eating fish or shellfish into a full state, prior to the feeding the algae-eating fish or shellfish with the plurality of samples.

4. A method of determining feed for algae-eating fish and shellfish,
the method comprising:
feeding algae-eating fish or shellfish with one or more samples, each of the one or more samples containing algal cells differing from each other in a stage of growth or division; and
selecting, as a feed for giving to the algae-eating fish or shellfish, the algal cells whose stage of growth or division is the same as that of the algal cells most preferably eaten by the algae-eating fish or shellfish.

5. The method according to claim 4, further comprising putting the algae-eating fish or shellfish into a fasted state, prior to the feeding the algae-eating fish or shellfish with the samples.

6. A method of feeding algae-eating fish and shellfish, the method comprising feeding the algae-eating fish or shellfish with the feed determined by the method according to claim 1.

7.-8. (canceled)

9. A method of feeding algae-eating fish and shellfish, the method comprising feeding the algae-eating fish or shellfish with the feed determined by the method according to claim 4.

10. The method according to claim 6, further comprising:
culturing the algal cells; and
obtaining, from the cultured algal cells, the algal cells which are in the same stage of growth or division as the algal cells most preferably eaten by the algae-eating fish or shellfish, as the feed.

11. The method according to claim 9, further comprising:
culturing the algal cells; and
obtaining, from the cultured algal cells, the algal cells which are in the same stage of growth or division as the algal cells most preferably eaten by the algae-eating fish or shellfish, as the feed.

12. A method of producing the feed determined by the method according to claim 1,
the method comprising:
culturing the algal cells; and
obtaining, from the cultured algal cells, the algal cells which are in the same stage of growth or division as the algal cells most preferably eaten by the algae-eating fish or shellfish, as the feed.

13. A method of producing the feed determined by the method according to claim 4,
the method comprising:
culturing the algal cells; and
obtaining, from the cultured algal cells, the algal cells which are in the same stage of growth or division as the algal cells most preferably eaten by the algae-eating fish or shellfish, as the feed.
